(19) United States
(12) Patent Application Publication
(10) Pub. No.: US 2012/0245011 A1
(43) Pub. Date: Sep. 27, 2012

(54) STRUCTURE OF PAPER CONVERTING MACHINE

(75) Inventor: Alessandro DE MATTEIS, Lucca (IT)

(73) Assignee: MTC - MACCHINE TRASFORMAZIONE CARTA S.R.L., Porcari (IT)

(21) Appl. No.: 13/426,946

(22) Filed: Mar. 22, 2012

(30) Foreign Application Priority Data
Mar. 22, 2011 (IT) PI 2011A000027

(51) Int. Cl. B26D 1/22; B65H 35/00; B31B 1/14; B26D 1/03

(52) U.S. Cl. 493/360; 83/401; 83/343; 83/30; 83/13; 83/161

(57) ABSTRACT

A paper converting or rewinding machine provides a cutting or perforation section, equipped with at least one blade arranged to work in combination with a stationary knife to provide the division of the web of paper into a plurality of sheets of measured length. The blade can be integral to a fixed support, or alternatively to a cutting roller that rotates about a longitudinal rotation axis. The blade(s) can be a perforation blade, or a cutting blade, with helical shape, and mounted to a perforation roller. The stationary knife can be mounted to a fixed roller. The blade performs a cutting, or perforation, of the web into sheets working in combination with the stationary knife. The blades and the stationary knifes are long substantially as the width of the paper. In particular, the blade has at least one weakened portion of determined size.

### FIELD OF THE INVENTION

The present invention relates to the field of converting paper and similar products, and precisely it relates to folding machines, or interfolding machines, for making paper material in stacks of interfolded sheets, or to rewinding machines for making logs of web material, for example used for making rolls of toilet paper, household paper towel rolls, nonwoven fabric, jumbo rolls and the like.

### BACKGROUND OF THE INVENTION

As well known, a variety of types exists of machines and of processes for making tissue paper products, paper towels and similar articles in stacks of folded, or interfolded sheets, such as U.S. Pat. No. 6,228,014.

Furthermore, rewinding machines exist for making logs of web material for example used for making rolls of toilet paper, household paper rolls, nonwoven fabric, jumbo rolls and the like, as described in U.S. Pat. No. 6,494,398.

In both types of machines, for tissue papers and for rolls, a web is subjected to a clean cut to make sheets of tissue paper, or a perforation on the paper for the rolls so that the user can separate by tearing the paper panels from one another.

The cut into sheets or the perforation of the webs is made through contact of two sharp edges, normally called blade and stationary knife, between which the paper passes. The blade and the stationary knife are metal plates constrained to a support and interact alternatively with each other. In some applications, one is fixed, and the other mounted to a paper conveying roller. In other cases, both the blade and the stationary knife are mounted to respective rollers.

The blades and stationary knives have the same length as the width of the web, in order to cut or perforate it for all its width, which is normally set between two and three metres for the above described types of machines. To allow a “scissors-like” cut or perforation, the blade and the stationary knife may have helical shape, giving rise to a cut or a perforation that is rectilinear and transversal to the web of paper, so that they contact each other for all the length not at the same time, but with a progressive sliding on each other. This avoids a hit between the two cutting edges and reduces the wear.

However, in the machines of known type, both interfolding and rewinding machines as above described, during the cutting or perforation step, owing to the high stiffness of the cutting edges and to the softness of the “tissue” paper used to make hygiene products such as napkins, toilet paper, etc., the web, or the cut sheet, can adhere to the surface of such profiles, jeopardizing the cutting or perforation step, and then the following step of conveying further the sheet or web.

In particular, if a cut sheet remains on the surface of the cutting edges it is possible that, during transfer steps, it can be torn, or in any case damaged, penalizing the quality of the final product.

Then, a product is obtained of inferior quality, with defects caused by the imperfect cutting step. In many cases, moreover, it is necessary to stop the machine for removing the web, or sheet, adhered to the surface of the blade.

In WO2008/015588 a paper converting machine is described comprising a cutting section equipped with a blade and a stationary knife. One of these has a plurality of teeth with distanced recesses distributed along the edge of the blade, or the stationary knife. Such example of the blade is commonly known in the paper converting field and has the object of providing perforation lines on the web of the processed paper, instead of a clean cut.

Also the solution described in WO2008/015588 has the above described drawback of the machines of the prior art.

### SUMMARY OF THE INVENTION

It is therefore a feature of the present invention to provide a machine structure for converting paper, or similar products, which improves the cutting phase of the web of paper, without causing the above described drawbacks.

It is still a feature of the present invention to provide a machine structure for converting paper, or similar products, which avoids to damage the web, or the sheet, during the cutting or perforation step, and then to optimize the quality of the final product, avoiding maintenance stops for removing the paper adhered to the surface of the blade.

These and other objects are accomplished by a converting machine paper, or similar products, according to the present invention, comprising:
a feeding section equipped with a means for feeding at least one web of paper along a feeding direction;
a cutting or perforation section comprising at least one first blade, or cutting blade, arranged to contact a second blade, or stationary knife, to provide the cutting, or perforation, of the web of paper;
wherein at least one of the blades comprises a plate of metal sheet having a main body and a cutting edge with a cutting profile;
   whose main feature is that the main body of the plate of metal sheet has at least one weakened portion arranged at a predetermined distance from the cutting edge, the or each weakened portion configured to reduce the stiffness of the plate of metal sheet in such a way that, when the first blade and the second blade contact each other, the weakened portion is configured to cause a modified resilient response that reduces contact forces between the blades and avoids that the web of paper, once cut or perforated, can adhere to the surface of the knives.

In particular, the or each weakened portion is adapted to reduce the elasticity modulus of the main body of the plate of metal sheet down to a predetermined value.

This way, it is avoided that the cut paper adhering to the surface of a blade can affect a correct cutting or perforation step, or a following transfer step downstream of the cutting or perforation section. This allows, therefore, to avoid damaging the cut web and to optimize the quality of the final product. Furthermore, it is avoided the need of a maintenance stop for removal of the web, cut or perforated, adhered to the surface of the blade.

According to the invention, the weakened portion in the plate of the blade is selected from the group consisting of:
at least one row of through holes;
at least one row of blind holes;
at least one longitudinal blind groove;
at least one longitudinal through groove.

In particular, the or each blade is arranged on a cutting or perforation roller.

In particular, the ratio between the area of the surface region defined by the perimeter of the plate and the actual area of the plate, i.e. removed the area of the, or each, weakened portion, is set between 1.2 and 2.2.

In particular, the, or each, weakened portion which is made on the plate has a geometry selected from the group consisting of:
substantially circular geometry;
substantially rectangular geometry;
substantially elliptical geometry;
a combination thereof.

According to a further aspect of the invention a method for converting paper, or similar products, according to the present invention, comprises the steps of:
feeding at least one web of paper along a feeding direction;
cutting or perforating the, or each, web of paper, the cut or perforation carried out by at least one blade that operates in combination with a stationary knife to cut or perforate the web of paper, wherein the blade comprises a main body and a cutting edge with a cutting profile, the main body having at least one weakened portion arranged at a predetermined distance from the cutting edge, the, or each, weakened portion configured to reduce the stiffness of the cutting edge in order to reduce the contact forces and avoid that the web once cut can adhere to the surface of the blade.

According to still another aspect of the invention, a rewinding machine, comprising a feeding section for feeding a web of paper, a cutting or perforating section of the web, and an unit for rewinding into rolls the web of paper, has the feature that the cutting or perforation section is made or operates as above defined.

According to still another aspect of the invention, a machine for interfolding or stacking sheets of paper comprising a feeding section for feeding a web of paper, a cutting or perforating section of the web, a folding section comprising folding means that is arranged to fold the sheets into a plurality of panels obtaining folded sheets in a predetermined folded configuration; a separation section for separating a stack of folded sheets from a stack being formed, has the feature that the cutting or perforation section is made or operates as above defined.

### BRIEF DESCRIPTION OF THE DRAWINGS

Further characteristic and the advantages of the folding and stacking machine, according to the invention, will be made clearer with the following description of an exemplary embodiment thereof, exemplifying but not limitative, with reference to the attached drawings, in which like reference characters designate the same or similar parts, throughout the figures of which:

FIG. 1A shows a conveying and cutting section of a paper converting machine, such as a tissue paper stacking machine or an interfolding machine;

FIG. 1B shows a conveying and perforation section of a paper converting machine, such as a rewinding machine;

FIGS. 2 to 5 diagrammatically show perspective views of some exemplary embodiments for the blades used by the paper converting machines, according to the invention;

FIGS. 6 and 7 diagrammatically show the blade, according to the invention, highlighting some possible geometric features;

FIGS. 8 to 10 diagrammatically show cross sectional views of some possible exemplary embodiments of the blade used by the paper converting machines, according to the invention;

FIGS. 11 and 12 diagrammatically show cross sectional views of the blade and the stationary knife, according to the invention, during a cutting step for highlighting particular properties and technical features;

FIGS. 13 and 14 diagrammatically show cross sectional views of an exemplary embodiment of the blade and of the stationary knife of FIGS. 11 and 12, according to the invention, engaging with a cutting step for highlighting particular properties and technical features.

### DESCRIPTION OF A PREFERRED EXEMPLARY EMBODIMENT

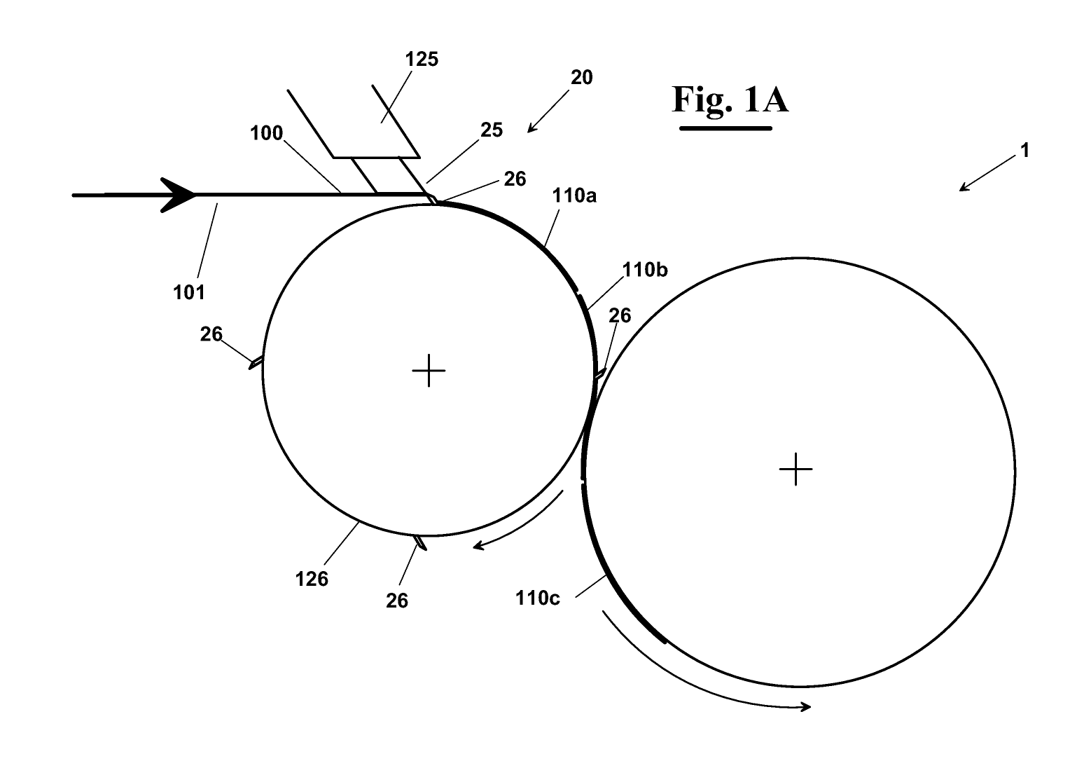

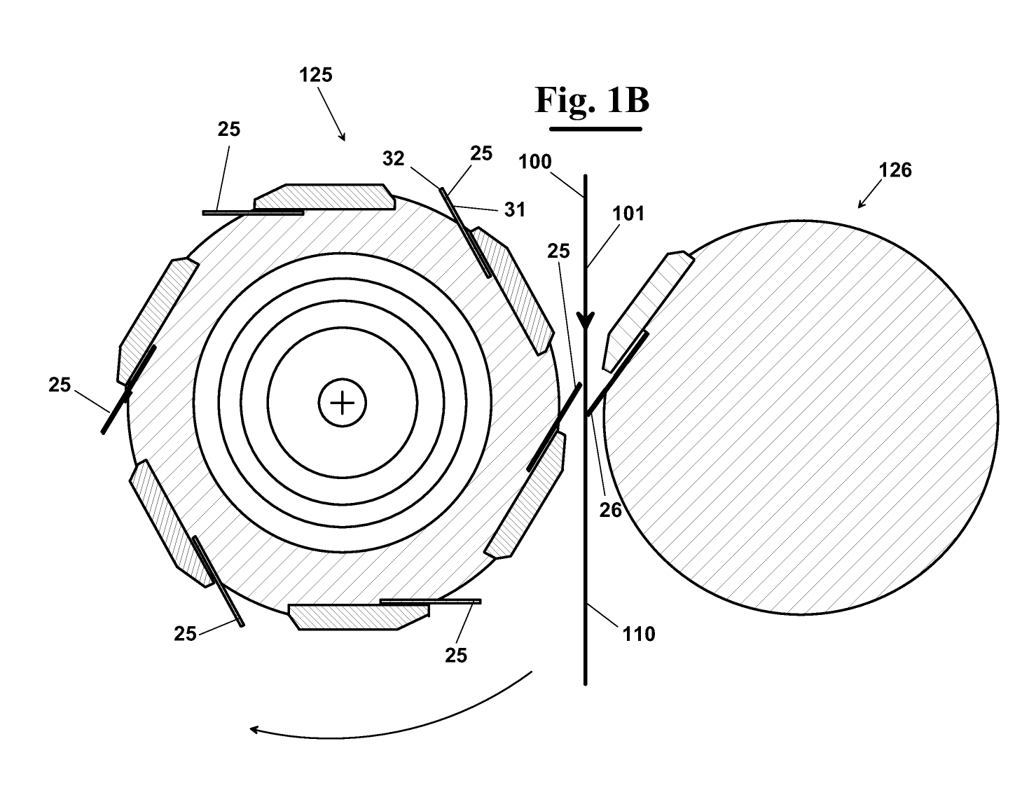

With reference to FIG. 1, a paper converting machine, according to the invention, such as a folding and stacking machine, or a rewinding machine, provides a cutting or perforation section 20, equipped with at least one blade 25, which is arranged to work in combination with a stationary knife 26 to provide the division of the web of paper 100 into a plurality of sheets 110 of measured length.

Blade 25 can be integral to a fixed support 125 (FIG. 1A), or alternatively to a cutting roller that rotates about a longitudinal rotation axis (not shown). In the case shown for example in FIG. 1B, the, or each, blade 25 can be a perforation blade, or a cutting blade, for example with helical shape, and is mounted to a perforation roller 125, whereas stationary knife 26 is mounted to a fixed roller 126. In both cases, blade 25 cuts or perforates web 100 into sheets 110, working in combination with stationary knife 26.

Blades 25 and stationary knifes 26 are as long substantially as the width of the paper, i.e. the length of roller 125, 126. For the sake of simplicity, in the following figures only one portion will be shown.

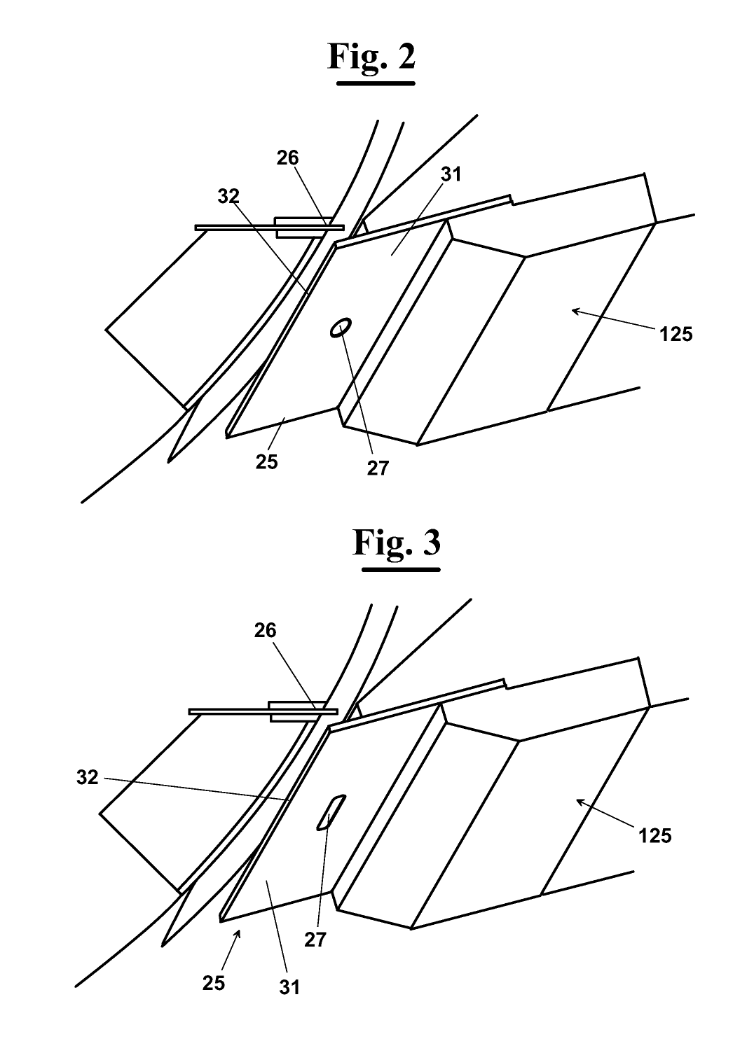

According to the invention and as shown in detail in FIGS. 2 to 5, blade 25, which comprises a main body 31 and a cutting edge 32 with a cutting profile, has at least one weakened portion 27 of determined size at the main body. More in detail, weakened portion 27 is arranged at a predetermined distance d from cutting edge 32. The presence of weakened portion 27 has the function of reducing the stiffness of blade 25 at main body 31 giving higher elasticity to blade 25 without changing the material with which it is made. This way, it is avoided that sheet 110, once cut, can adhere to the surface of blade 25.

Downstream of the cutting or perforation section 20, in a way not shown, a folding and stacking section can be present, or a rewinding section, according to the type of converting machine of which the cutting or perforation section makes part.

In an exemplary embodiment shown in detail in FIG. 2, blade 25 has a weakened portion 27 with substantially circular shape. In the exemplary embodiment of FIG. 3, weakened portion 27 has, instead, a substantially rectangular shape.

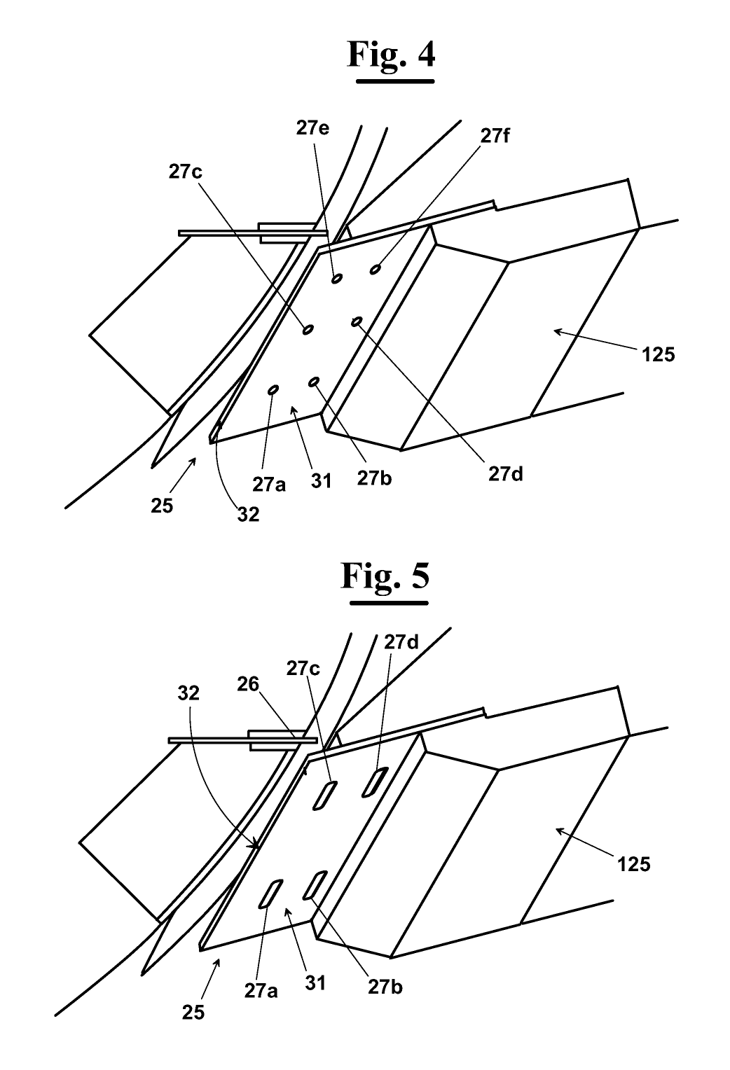

In the further exemplary embodiments shown in FIGS. 4 and 5, a predetermined portion of blade 25 has a predetermined number of weakened portions, for example six weakened portions 27a-27f with substantially circular shape, in the exemplary embodiment of FIG. 4, and four holes 27a-27d of substantially rectangular shape in the exemplary embodiment of FIG. 5.

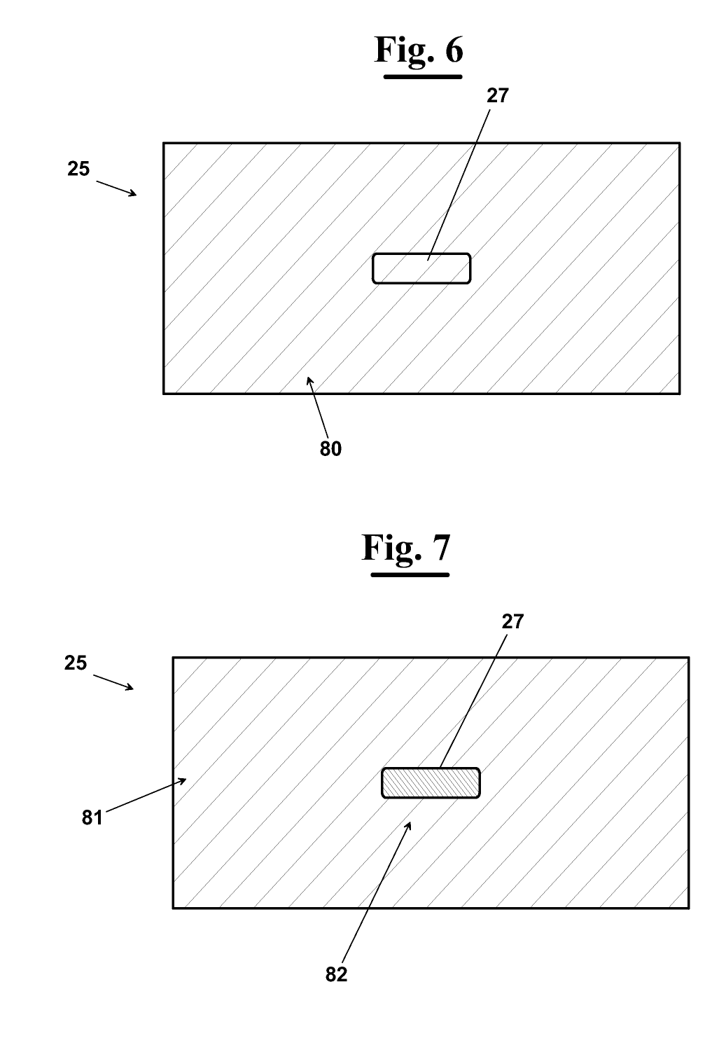

In all the exemplary embodiments shown in FIGS. 2 to 5, the ratio between the area 80 of the surface region defined by the perimeter of blade 25 (FIG. 6) and the actual area 81 of blade 25, i.e. the area obtained from subtraction of area 82 from area 80, of the or each weakened portion 27, can be set between 1.1 and 2.5, as optimal compromise between decrease of the stiffness of the blade and residue mechanical resistance of the blade.

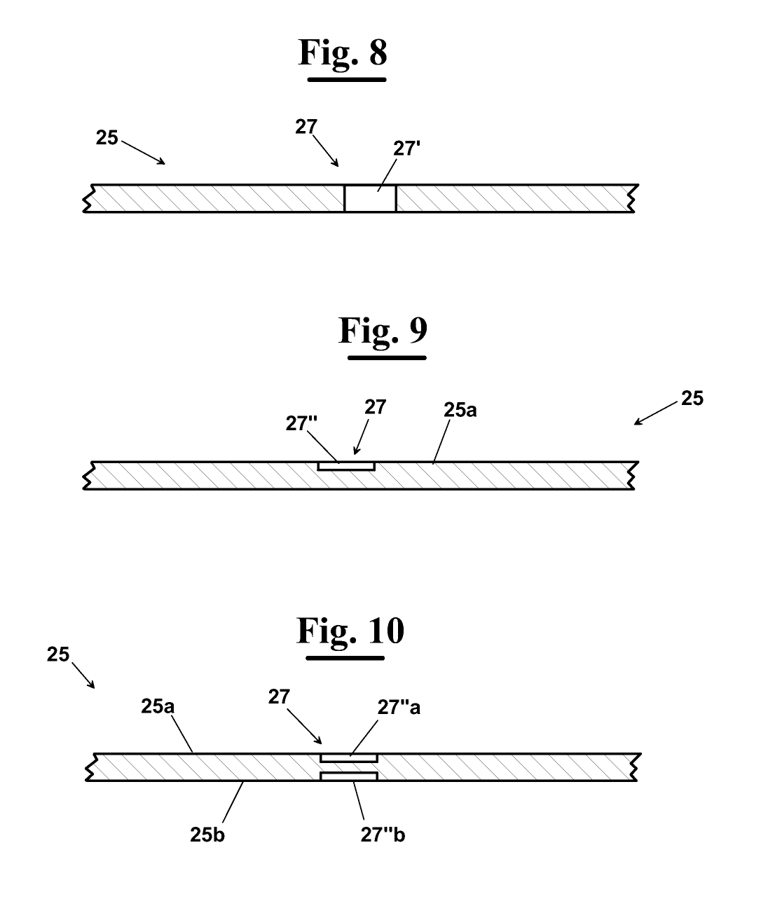

As shown in detail in the cross sectional views of FIGS. 6 to 8, the, or each, weakened portion 27 can be obtained from a through hole 27′ (FIG. 8), a groove, or a blind hole, 27″ made on a side 25a of blade 25 (FIG. 9), or a first groove 27″a, or first blind hole, made on the side 25a of blade 25 and a second groove 27″b, or second blind hole, made on the side 25b of blade 25 (FIG. 10).

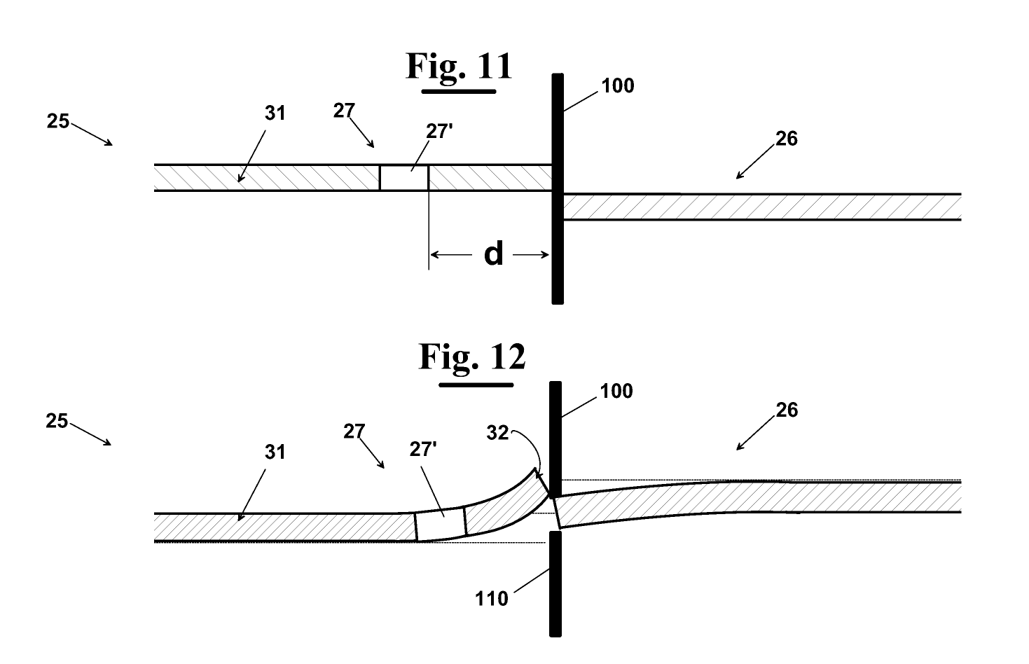

As shown in detail in FIGS. 11 and 12, the presence of the or each weakened portion 27 reduces the overall elasticity modulus E of blade 25 down to a predetermined value. During the cutting phase of the web of paper 100, the presence of weakened portion 27 causes blade 25 to bend much more than stationary knife 26, without weakened portions. More precisely, the presence of weakened portion 27 owing to the hole, or to the groove, 27′ produces an increase of the resilient deformation of blade 25. Such reduces the contact forces between blade 25 and stationary knife 26 and therefore avoids that the paper adheres to their surfaces during the cut.

This way, it is avoided that web 100, or sheet 110, for example of “tissue” paper, can adhere to the surface of blade 25, and then affect a correct cutting step, or perforation step, or following conveying step of the cut sheet 110 from the cutting or perforation section, 20 to a following separation section. This allows, therefore, to avoid damaging the cut sheet, and to optimize then the quality of the product. Furthermore, it is avoided the need of maintenance stops for removal of the cut sheet from the surface of the blade.

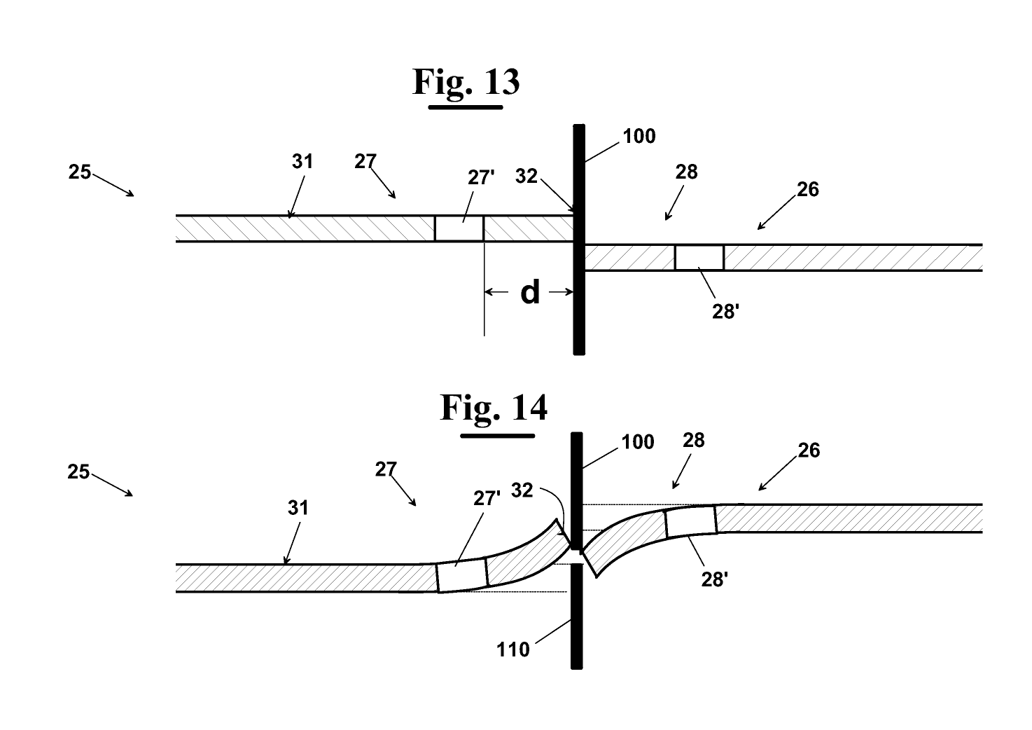

In the exemplary embodiment of FIGS. 13 and 14, both blade 25 and stationary knife 26 comprise respective weakened portions 27 and 28. In this case, both the elasticity modulus E of blade 25 that the elasticity modulus E′ of stationary knife 26 are reduced to a predetermined value with effects and results similar to those above described.

In the case shown, both weakened portion 27 of blade 25 and the weakened portion 28 of stationary knife 26 are obtained from respective through holes 27′ and 28′ in predetermined positions. It is in any case possible to provide the above described weakened portions 27 and 28 through a desired combination of the alternative embodiments above described, i.e. at least one groove, or at least one hole, through or blind.

The foregoing description of specific exemplary embodiments will so fully reveal the invention according to the conceptual point of view, so that others, by applying current knowledge, will be able to modify and/or adapt in various applications the specific exemplary embodiments without further research and without parting from the invention, and, then it is meant that such adaptation and modifications will have to be considered as equivalent to the specific embodiment. The means and the materials to realise the different functions described herein could have a different nature without, for this reason, departing from the field of the invention. It is to be understood that the phraseology or terminology that is employed herein is for the purpose of description and not of limitation.

1. Converting machine paper, or similar products, according to the present invention, comprising:
a feeding section equipped with a means for feeding at least one web of paper along a feeding direction;
a cutting or perforation section, comprising at least one first blade, or cutting blade (25), arranged to contact a second blade, or stationary knife (26), to provide the cutting, or perforation, of the web of paper; wherein at least one of the blades (25, 26) comprises a plate of metal sheet, the plate having a main body (31) and a cutting edge (32) with a cutting profile;
wherein the main body (31) of the plate of metal sheet has at least one weakened portion (27, 28) arranged at a predetermined distance from the cutting edge (32), the or each weakened portion (27, 28) configured to reduce the stiffness of the plate of metal sheet in such a way that, when the first blade and the second blade contact each other, the weakened portion (27, 28) is configured to cause a modified resilient response that reduces contact forces between the blades and avoids that the web of paper, once cut or perforated, can adhere to the surface of the blades (25, 26).

2. Machine, according to claim 1, wherein the weakened portion (27, 28) in the plate of the blade is selected from the group consisting of:
at least one row of through holes;
at least one row of blind holes;
at least one longitudinal blind groove;
at least one longitudinal through groove.

3. Machine, according to claim 1, wherein the, or each, blade is arranged on a cutting or perforation roller.

4. Machine, according to claim 1, wherein the ratio between an area of a surface region defined by the perimeter of the plate and an actual area of the plate, i.e. removed the area of the, or each, weakened portion (27, 28), is set between 1.1 and 2.5.

5. Machine, according to claim 1, wherein the, or each, weakened portion (27, 28) made on the plate has a geometry selected from the group consisting of:
substantially circular geometry;
substantially rectangular geometry;
substantially elliptical geometry;
a combination thereof.

6. Method for converting paper, or similar products wherein it comprises the steps of:
feeding at least one web of paper along a feeding direction;
cutting or perforating the, or each, web of paper, a cut or perforation carried out by at least one blade (25) that operates in combination with a stationary knife (26) to cut or perforate the web of paper, wherein the blade (25) comprises a main body (31) and a cutting edge (32) with a cutting profile, the main body having at least one weakened portion (27, 28) arranged at a predetermined distance from the cutting edge (32), the, or each, weakened portion (27, 28) configured to reduce the stiffness of the cutting edge to avoid that the web once cut can adhere to the surface of the blade (25).

7. A rewinding machine, comprising a feeding section for feeding a web of paper, a cutting or perforation section, of the web, and a unit for rewinding into rolls the web of paper, wherein the cutting or perforation section is made according to the method of claim 1.

8. A machine for interfolding or stacking sheets of paper comprising a feeding section for feeding a web of paper, a cutting or perforation section, of the web, a folding section comprising folding means that is arranged to fold the sheets into a plurality of panels obtaining folded sheets in a predetermined folded configuration; a separation section for separating a stack of folded sheets from a stack being formed, wherein the cutting or perforation section is made according to the method of claim 1.
